(19) United States
(12) Patent Application Publication
(10) Pub. No.: US 2009/0052670 A1
(43) Pub. Date: Feb. 26, 2009

(54) METHOD AND APPARATUS FOR STORING DIGITAL CONTENT IN STORAGE DEVICE

(75) Inventors: Yong-kuk YOU, Seoul (KR); Chang-sup AHN, Seoul (KR); So-young LEE, Hwaseong-si (KR); Bong-seon KIM, Yongin-si (KR); Ji-young MOON, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/194,860

(22) Filed: Aug. 20, 2008

Related U.S. Application Data
(60) Provisional application No. 60/956,978, filed on Aug. 21, 2007.

(30) Foreign Application Priority Data
Dec. 21, 2007 (KR) 10-2007-0135245

(51) Int. Cl. H04L 9/06

(52) U.S. Cl. 380/277

(57) ABSTRACT

Disclosed are a method and apparatus for storing digital content in a storage device. A content key, which is a key used by a host for encrypting content when the content is stored to a storage device connected to the host, is encrypted by using a storage key of the storage device. The encrypted content key and encrypted content are stored in the storage device, and the host only stores storage keys. Thus, quantity of information maintained by the host can be reduced. Also, when a storage key is stored in a portable security component (PSC), portability and mobility of content bound to a single host may be improved.

### CROSS-REFERENCE TO RELATED PATENT APPLICATION

This application claims priority of U.S. Provisional Patent Application No. 60/956,978, filed on Aug. 21, 2007, in the U.S. Patent and Trademark Office, and Korean Patent Application No. 10-2007-0135245 filed on Dec. 21, 2007, in the Korean Intellectual Property Office, the disclosures of which are incorporated herein in their entirety by reference.

### BACKGROUND OF THE INVENTION

1. Field of the Invention

The present invention relates to methods of protecting digital content, and more particularly, to methods of storing digital content in a storage device and managing the storage device, and associated apparatus.

2. Description of the Related Art

Due to developments in communication technology, the size of digital content is continuously increasing. As a result, numerous high-capacity storage devices for storing digital content are being introduced to the market. Technically, digital content can be unlimitedly reproduced without quality deterioration, and thus it is necessary to prevent digital content from being used by an unauthorized user. For example, when a set-top box for receiving digital content receives broadcasted content and stores the broadcasted content in a storage device connected to the set-top box, it is necessary to forbid playback of the content stored in the storage device when the storage device is connected to another set-top box.

Accordingly, various digital right management (DRM) technologies for protecting digital content are being researched. However, a storage device is generally a non-intelligent device that is unable to perform calculations required for content protection, A host copying content to a storage device, the host including set-top boxes, digital televisions (TV), etc., is required to perform appropriate encryption on the content before the content is stored in the storage device.

FIG. 1 is a flowchart of a method wherein a host stores digital content in a storage device in the related art.

In operation 110, the host generates a content key.

In operation 120, the host encrypts content, which is to be stored in the storage device, by using the content key.

In operation 130, the encrypted content is stored in the storage device connected to the host.

In operation 140, the content key is encrypted by using a device key of the host. The device key of the host is a key not known to any devices other than the host.

In operation 150, the host stores the encrypted content key in a safe region within the host, together with information mapping the content key and content corresponding to the content key.

Once content is stored in the storage device according to the aforementioned method, the content cannot be played back when the storage device is connected to another host. Since the content key is stored in the original host, other devices cannot decrypt the encrypted content. Therefore, the content can only be played back in the original host, which hereinafter will be referred as the content being ‘bound’ to the original host.

However, according to the related art described above, a host needs to manage a large number of content keys. In other words, the host needs to have content keys for all contents the host encrypted and stored, and thus the host may be overloaded after a period of time.

Also, a host to which content is bound is required for either playing back the content in another host or moving the content to another storage device. However, a host device is generally not very portable, and thus portability and mobility of content is very low in the related art.

### SUMMARY OF THE INVENTION

The present invention provides a method in which a host does not need to store all content keys when digital content is stored in a storage device.

The present invention also provides a method of easily moving content that is bound to a host to another device.

According to an aspect of the present invention, there is provided a method of a host storing digital content in a storage device, the method including encrypting the content by using a content key, encrypting the content key by using a storage key, which is a key unique to the storage device, and storing a content key file, in which the encrypted content key is included, and the encrypted content in the storage device.

The storage key is a first storage key generated by a portable security component (PSC) connected to the host, and the method may further include removing the first storage key from the host after the storing of the content key file and the encrypted content is completed.

The method may further include determining whether a second storage key, which is a key corresponding to the storage device and is generated by the host, already exists in the host or not, extracting the second storage key from the host or newly generating the second storage key, based on a result of the determination, updating the content key file by using the second storage key, encrypting the second storage key by using a device key of the host, and storing the encrypted second storage key in the host.

The update of the content key file may further include decrypting the encrypted first storage key by using a device key of the PSC, decrypting the content key included in the content key file by using the first storage key, encrypting the decrypted content key by using the second storage key, and replacing the content key encrypted by using the second storage key with the content key encrypted by using the first storage key.

The storage key is a second storage key generated by the host, and the method may further include encrypting the second storage key by using a device key of the host, and storing the encrypted second storage key in the host.

The method may further include receiving a first storage key corresponding to the storage device, wherein the key is generated by a PSC connected to the host, and updating the content key file by using the first storage key.

The update of the content key file may include decrypting the encrypted second storage key by using the device key of the host, decrypting the content key included in the content key file by using the decrypted second storage key, encrypting the decrypted content key by using the first storage key, and replacing the content key encrypted by using the first storage key with the content key encrypted by using the second storage key.

The method may further include searching for the storage key in either the host or a PSC when a request to play back the content is received, and selectively playing back the encrypted content based on a result of the searching.

The selective playback of the encrypted content may include decrypting a content key, which is included in the content key file, by using the storage key when the storage key is located by the searching, and decrypting the encrypted content by using the decrypted content key.

The storage device is a first storage device, and the method may further include receiving an instruction to move the content from the first storage device to a second storage device, decrypting the encrypted content key by using a first storage key, encrypting the decrypted content key by using a second storage key, which is a storage key corresponding to the second storage device, storing a content key file comprising the content key, which is encrypted by using the second storage key, and the encrypted content in the second storage device, and deleting a content key file and encrypted content stored in the first storage device.

The content key file may further include a value for checking integrity of the content key file.

The content key file may further include a recovery key, which is generated by encrypting the storage key by using a public key of a third-party manufacturer or a public key of the host.

According to another aspect of the present invention, there is provided a computer readable recording medium having recorded thereon a computer program for executing a method which includes encrypting the content by using a content key, encrypting the content key by using a storage key, which is a key unique to the storage device, and storing a content key file, in which the encrypted content key is included, and the encrypted content in the storage device.

According to another aspect of the present invention, there is provided a host storing digital content in a storage device, the host including a content encrypting unit encrypting the content by using a content key, a content key encrypting unit encrypting the content key by using a storage key, which is a key unique to the storage device connected to the host, and a storage control unit storing a content key file including the encrypted content key and the encrypted content in the storage device.

According to exemplary embodiments of the present invention, a host is only required to manage a storage key per storage device, and thus quantity of information the host is required to manage can be safely reduced.

Also, as long as a user has a storage device storing contents and a PSC storing storage keys, the user can freely play back and/or move content bound to the PSC in any host to which the storage device is connected.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of a method wherein a host stores digital content in a storage device in the related art;

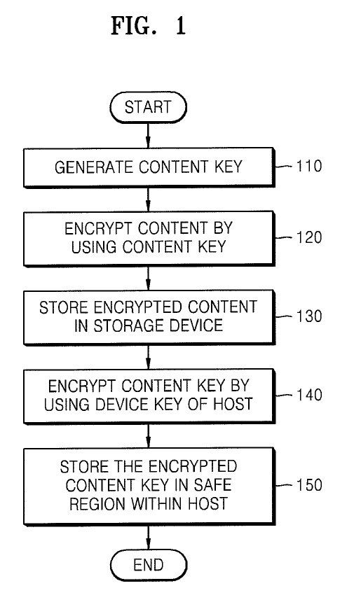

FIG. 2A is a diagram of the structure of data stored in a host and a storage device, according to an exemplary embodiment of the present invention;

FIG. 2B is a diagram of the structure of data stored in a host and a storage device, according to another embodiment of the present invention;

FIG. 3 is a flowchart showing a process whereby a host stores content in a storage device, according to an exemplary embodiment of the present invention;

FIG. 4 is a flowchart showing a process of binding content, which is bound to a portable security component (PSC), to a host, according to an exemplary embodiment of the present invention;

FIG. 5 is a flowchart showing a process of binding content, which is bound to a host, to a PSC, according to an exemplary embodiment of the present invention;

FIG. 6 is a flowchart showing a process whereby a host plays back content stored in a storage device, according to an exemplary embodiment of the present invention;

FIG. 7 is a flowchart showing a process of moving content stored in a storage device, according to an exemplary embodiment of the present invention; and

FIG. 8 is a diagram showing the structure of a host according to an exemplary embodiment of the present invention.

### DETAILED DESCRIPTION OF EXEMPLARY EMBODIMENTS OF THE INVENTION

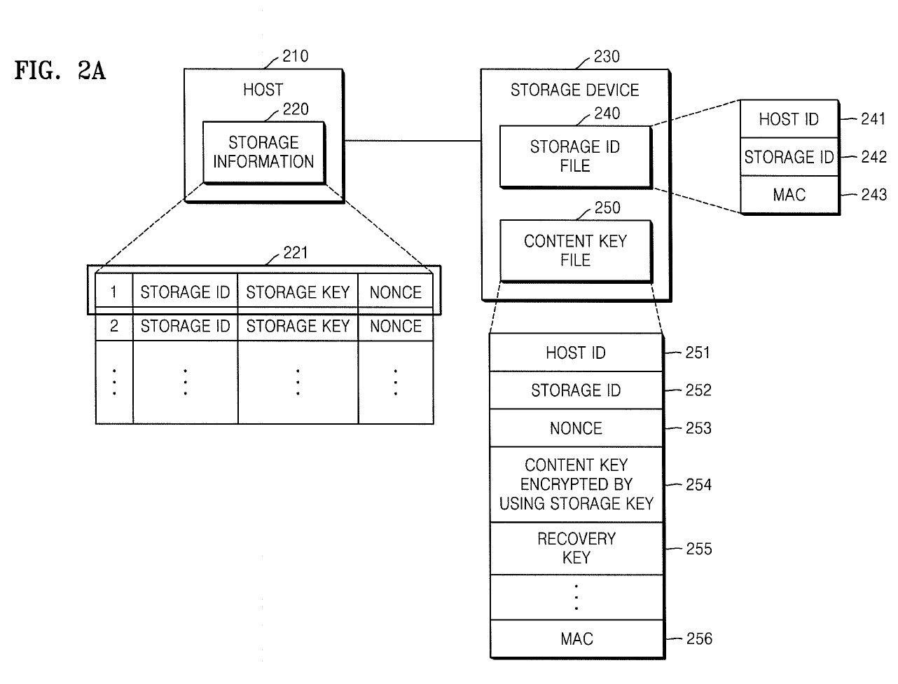

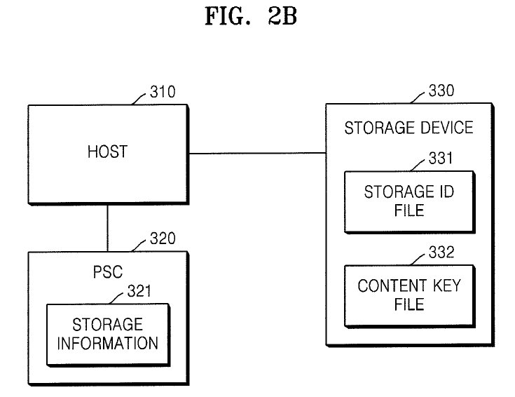

The present invention will now be described more fully with reference to the accompanying drawings, in which exemplary embodiments of the invention are shown. p FIG. 2A is a diagram of the structure of data stored in a host 210 and a storage device 230, according to an embodiment of the present invention.

As shown in FIG. 2A, storage information 220 is stored in the host 210, and not only encrypted content (not shown) but also a storage ID file (240) and a content key file 250 are stored. A communication interface between the host 210 and the storage device 230 is not limited to a particular interface.

The host 210 generates a storage ID file 240 for every storage device connected to the host 210 and stores the storage ID file 240 in the corresponding storage device. When a storage device is connected, the host 210 uses a storage ID file 240 stored in the storage device to identify the storage device.

The storage ID file 240 includes a host ID 241, a storage ID 242, and a message authentication code (MAC) 243. An electronic signature value may be used instead of the MAC 243.

The host ID 241 is an identifier of the host 210 itself The storage ID 242 is an identifier of the storage device 230, and the MAC 243 is a value for checking the integrity of the storage ID file 240.

It may be difficult to extract ultimately unique identifiers from all storage devices. Thus, the storage ID 242 is generated by the host 210 as a unique value which is any value sufficient for the host 210 to distinguish the storage device 230 from other storage devices and is stored in the storage device 230. The storage ID 242 is also included in the storage information 220, and thus the storage ID 242 may be used as index information when the host 210 searches for a storage key for the corresponding storage device 230 from the storage information 220. When a storage device 230 is connected to the host 210, the host 210 searches for a storage ID file 240 for the storage device 230. If the host 210 fails to locate the storage ID file 240 for the storage device 230, the host 210 newly generates a storage ID file 240 for the storage device 230.

The storage information 220 includes a storage ID, a storage key, and a nonce. The storage ID is identical to the storage ID 242 in the storage ID file 240 and a storage ID 252 in the content key file 250.

A nonce is a value that the host 210 randomly generates for each storage device, and is generated so that a previously used value will not show up again even if the nonce is updated. When the nonce is stored in the host 210, the nonce may be encrypted by using a device key of the host 210 before being stored. Meanwhile, the nonce is also included in the content key file 250 stored in the storage device 230.

The nonce may be used for preventing a possible disk cloning attack. In other words, when content stored in the storage device 230 is moved to another storage device, the host 210 deletes a content key file corresponding to the moved content from the storage device 230, locates storage information elements 221 including a storage ID of the storage device 230, and updates a nonce corresponding to the storage device 230. Nonces of other content key files stored in the storage device 230 are also synchronized to nonces in the storage information 220.

Thus, even when an attacker copies content of an original storage device bit by bit before the content is moved, the moved content cannot be played back by the host 210. However, the host 210 is required to play back the content only if the host 210 compares the nonce in the storage information 220 and the nonce in the content key file 250 and the nonces are identical to each other.

Whenever the host 210 stores content in the storage device 230, the host 210 generates a content key file 250 for the content and stores the content key file 250 in the storage device 230. The content is encrypted by using a content key and is stored in the storage device 230. The content key is encrypted by using a storage key, which is the device key of the storage device 230, and is included in the content key file 250. Accordingly, the content key is not stored in the host 210, but is included in the content key file 250 stored in the storage device 230. Thus, the host 210 manages storage keys for storage devices, instead of content keys for all contents.

The content key file 250 includes a host ID 251, a storage ID 252, a nonce 253, a content key 254, a recovery key 255, and a MAC 256. The recovery key 255 is generated by encrypting a storage key of the storage device 230 by using a public key of a third-party manufacturer, which may be a manufacturer of the storage device 230, for example. A public key of a device to which corresponding content is bound, wherein the device is the host 210 in the present embodiment, may also be used for encrypting the storage key of the storage device 230. The recovery key 255 is for guarding against a case in which the storage key cannot be recovered due to either loss of the host 210 or loss of the storage information 220.

Other information included in the content key file 250 is described above, and thus descriptions thereof will be omitted here. Other than the aforementioned information, the content key file 250 may further include copy control information (CCI), a content ID, etc.

FIG. 2B is a diagram of the structure of data stored in a host 310 and a storage device 330, according to another embodiment of the present invention.

As shown in FIG. 2B, storage information 321 is included in a portable security component (PSC) 320 in the present embodiment, unlike the previous embodiment shown in FIG. 2A. The PSC 320 is connected to the host 310, generates a storage ID and a nonce for the storage device 330, and the storage ID and the nonce are included in the storage information 321. The storage key may be encrypted by using a device key of the PSC 320.

The storage information 321, a storage ID file 331, and a content key file 332 are respectively identical to the storage information 220, the storage ID file 240, and the content key file 250 shown in FIG. 2A, except that the storage information 321, the storage ID file 331, and the content key file 332 include a PSC ID instead of a host ID that is included in the storage information 220, the storage ID file 240, and the content key file 250. Although not shown, in the present embodiment, encrypted content is also stored in the storage device 330.

According to the present embodiment, content is bound to the PSC 320, not to the host 310. Therefore, when a user connects the storage device 330 to another host, content stored in the storage device 330 can be freely used if the user connects the PSC 320 to the host.

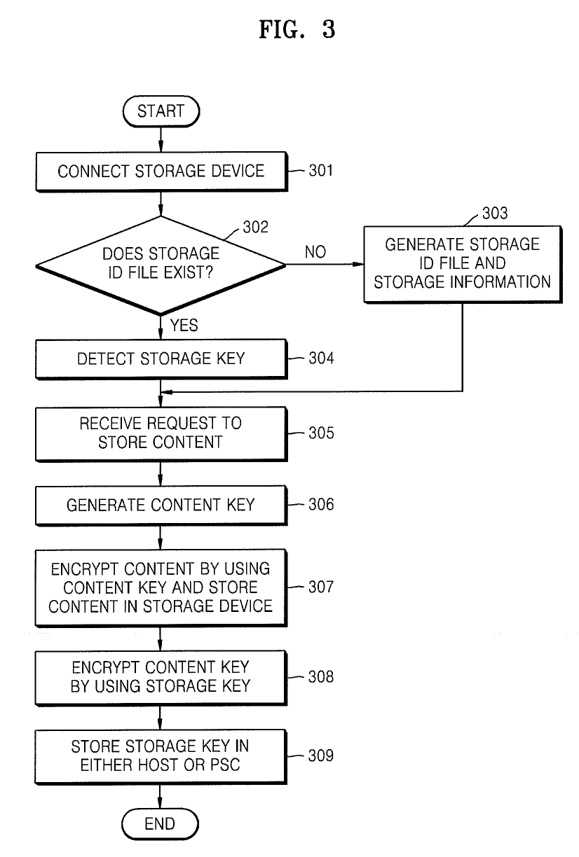

FIG. 3 is a flowchart showing a process whereby a host stores content in a storage device, according to an embodiment of the present invention.

In operation 301, the storage device is connected to the host.

In operation 302, the host determines whether an appropriate storage ID file exists in the storage device by referring to a host ID (or PSC ID) and a storage ID, which are included in storage ID files.

In operation 303, if the appropriate storage ID file does not exist, a storage ID file and storage information are generated. When content is bound to a PSC, the storage file and a storage ID included in storage information are received from the PSC.

In operation 304, the host detects a storage key from the storage information.

In operation 305, a request to store content is received via a user interface.

In operation 306, the host generates a content key.

In operation 307, the content is encrypted by using the generated content key and is stored in the storage device.

In operation 308, the content key is encrypted by using the storage key.

In operation 309, the storage key is stored in either the host or the PSC. The storage key may be encrypted by a device key of either the host or the PSC.

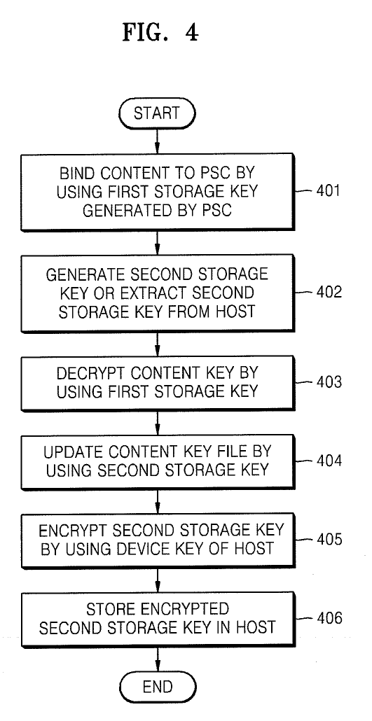

FIG. 4 is a flowchart showing a process of binding content, which is bound to a PSC, to a host, according to an embodiment of the present invention.

Operation 401 is a process of binding content to the PSC by using a first storage key, which is generated by the PSC regarding a storage device. Description of the process is mentioned in the descriptions regarding FIG. 3, and thus will be omitted here.

In operation 402, the host searches for storage information corresponding to the storage device and determines whether a storage key corresponding to the storage device is stored in the host or not. If the storage key is stored in the host, the host extracts the storage key from the storage information. If the storage key is not stored in the host, the host newly generates a storage key. Hereinafter, the storage key generated by the host will be referred as a second storage key.

In operation 403, the host decrypts a content key included in a content key file by using the first storage key, that is, a storage key generated by the PSC.

In operation 404, the host updates the content key file using the second storage key. In other words, the host encrypts the content key, which is decrypted in operation 403, by using the second storage key and replaces the existing content key encrypted by using the first storage key by the content key encrypted by using the second storage key. Also, PSC IDs included in the content key file and the storage ID file are replaced by the IDs.

In operation 405, the second storage key is encrypted by using a device key of the host.

In operation 406, the encrypted storage key is stored in a non-volatile memory of the host.

As a result, the second storage key stored in the host is required to decrypt encrypted content stored in the storage device, and thus the content is bound to the host.

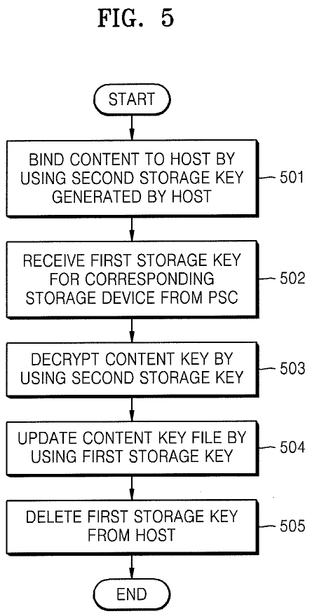

FIG. 5 is a flowchart showing a process of binding content, which is bound to a host, to a PSC, according to an embodiment of the present invention.

Operation 501 is a process whereby the host binds content to the host by using a second storage key, which is generated by the host regarding a storage device. A description of the process may be replaced by the descriptions regarding FIG. 3.

In operation 502, the host searches storage information stored in the PSC and determines whether a storage key corresponding to the storage device is stored in the PSC. If the PSC and the storage device have been connected before, the storage information should be stored in the PSC. If the storage information is stored in the PSC, the host extracts the storage key from the storage information stored in the PSC. If the PSC does not have the storage key, the host requests the PSC to generate a new storage key and receives the newly generated storage key from the PSC. Hereinafter, the storage key generated by the PSC will be referred to as a first storage key.

In operation 503, the host decrypts a content key in a content key file by using a second storage key, which is the storage key generated by the host.

In operation 504, the host updates the content key file by using the first storage key. In other words, the host encrypts the content key, which is decrypted in operation 503, by using the first storage key and replaces the existing encrypted content key, which is encrypted by using the second storage key, by the content key encrypted by using the first storage key. Operation 504 may include generating a new content key file and deleting the existing content key file.

Also, a host ID included in the content key file is replaced by a PSC ID.

In operation 505, the first storage key is deleted from the host. The first storage key in the host needs to be deleted, because content bound to the PSC can be played back in the host if the first storage key remains in the host.

Accordingly, the first storage key stored in the PSC is required to decrypt encrypted content stored in the storage device, and thus the content is bound to the PSC. In other words, a user can play back content stored in the storage device in any hosts by using the PSC.

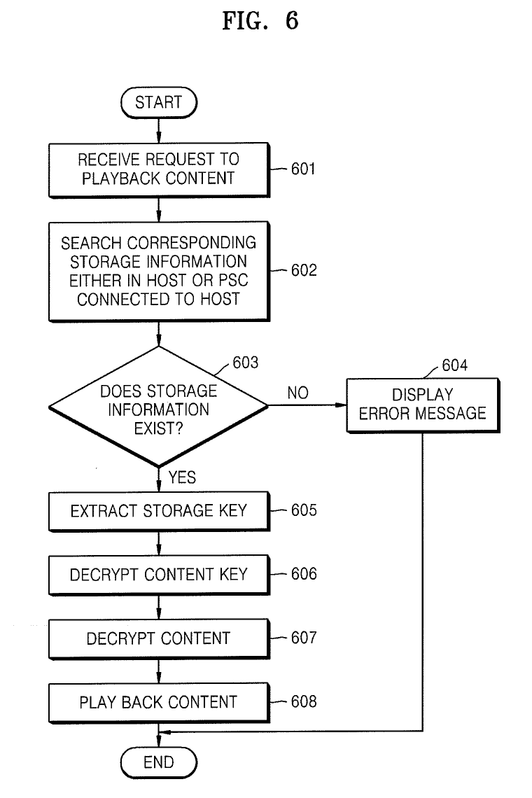

FIG. 6 is a flowchart showing a process whereby a host plays back content stored in a storage device, according to an embodiment of the present invention.

In operation 601, the host receives a request to play back content stored in the storage device via a user interface.

In operation 602, the host confirms either a host ID or a PSC ID of a content key file, and searches for corresponding storage information from either a non-volatile memory of the host or a PSC connected to the host. In other words, the host uses a storage ID file or a storage ID included in the content key file as index information for searching for the corresponding storage information.

In operation 603, the host determines whether there exists storage information having a storage ID corresponding to the request.

In operation 604, if the storage information doesn't exist, the host displays an error message to a user and terminates the process.

In operation 605, if the storage information exists, the host extracts a storage key from the storage information.

In operation 606, a content key included in the content key file is decrypted by using the storage key.

In operation 607, content stored in the storage device is decrypted by using the decrypted content key.

In operation 608, the decrypted content is played back.

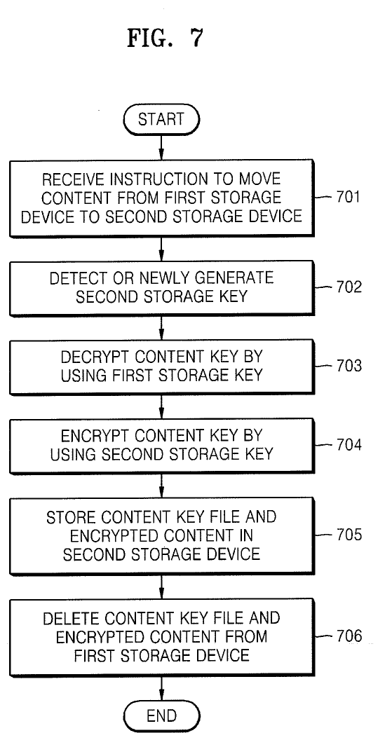

FIG. 7 is a flowchart showing a process of moving content stored in a storage device, according to an embodiment of the present invention. In other words, a device to which the content is bound is unchanged, but the content is stored in another storage device. At this point, the content should be bound to a host performing the operations described below or to a PSC connected to the host.

In operation 701, the host receives a request to move the content from a first storage device to a second storage device via a user interface.

In operation 702, the host either detects or newly generates a second storage key, which is a storage key regarding the second storage device. In other words, the host extracts a second storage key if the second storage key is included in the existing storage information, and the host newly generates a second storage key if the second storage key is not included in the storage information.

In operation 703, the host decrypts a content key, which is included in a content key file of the first storage device, by using a first storage key. The first storage key can be extracted from either a non-volatile memory in the host or the PSC connected to the host.

In operation 704, the host encrypts the content key by using the second storage key and generates a content key file. The newly generated content key file includes a storage ID, a nonce, a recovery key, and a MAC, which are different from those in the content key file in the first storage device.

In operation 705, the generated content key file and encrypted content are stored in the second storage device.

In operation 706, the content key file and encrypted content are deleted from the first storage device.

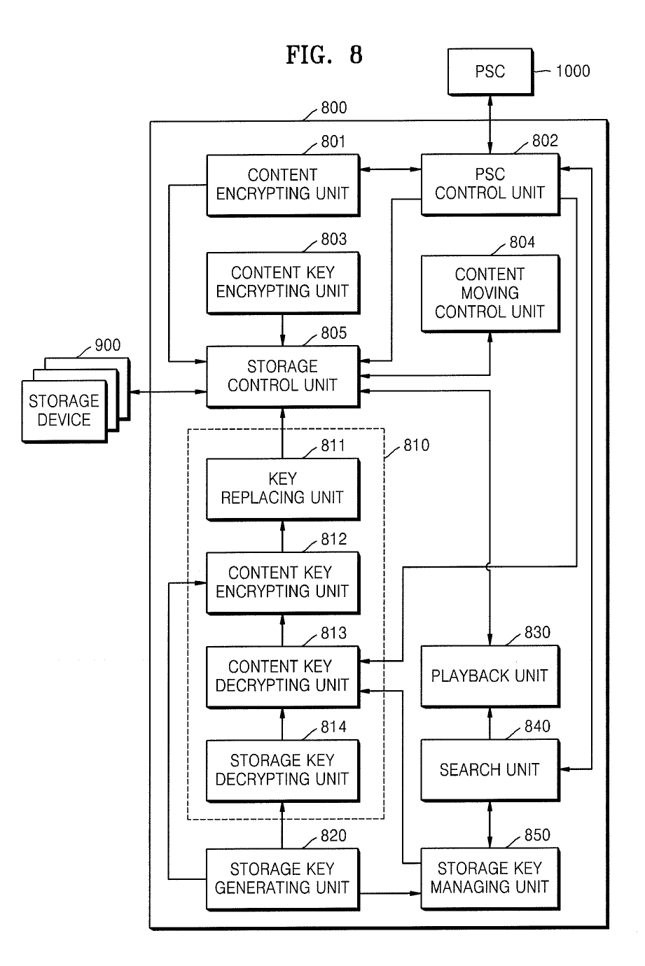

FIG. 8 is a diagram showing the structure of a host 800 according to an embodiment of the present invention.

As shown in FIG. 8, the host 800 includes a content encrypting unit 801, a PSC control unit 802, a content key encrypting unit 803, a content moving control unit 804, a storage control unit 805, an updating unit 810, a storage key generating unit 820, a playback unit 830, a search unit 840, and a storage key managing unit 850.

The content encrypting unit 801 encrypts content by using a content key.

The content key encrypting unit 803 encrypts the content key by using a storage key of a storage unit 900.

The storage control unit 805 stores a content key file and the encrypted content in the storage device 900.

The PSC control unit 802 receives a storage key generated by a PSC 1000 regarding the storage device 900 and deletes the storage key from the host 800 after the content is bound to the PSC.

When the storage device 900 is connected to the host 800, the storage key generating unit 820 determines whether storage information corresponding to the storage device 900 exists in a non-volatile memory (not shown) of the host 800. If the storage information corresponding to the storage device 900 exists, the storage key generating unit 820 extracts a storage key from the storage information. If the storage information corresponding to the storage device 900 does not exist, the storage key generating unit 820 newly generates a storage key.

The storage key managing unit 850 encrypts the storage key, which is generated by the storage key generating unit 820, by using a device key of the host 800 and stores the encrypted storage key in the non-volatile memory of the host 800.

The updating unit 810 updates a content key file, which is stored in the storage device when content bound to the host 800 is bound to the PSC 1000 or vice versa. As shown in FIG. 8, the updating unit 800 includes a key replacing unit 811, a content key encrypting unit 812, a content key decrypting unit 813, and a storage key decrypting unit 814.

First, the storage key decrypting unit 814 extracts a storage key stored in either the host 800 or the PSC 1000.

The content key decrypting unit 813 decrypts a content key, which is included in a content key file, by using the storage key.

The content key encrypting unit 812 re-encrypts the content key by using a storage key generated by a device to which the content is to be bound. For example, when content bound to the host 800 is to be bound to the PSC 1000, the content key encrypting unit 812 encrypts a content key by using a storage key generated by the PSC 1000 regarding the storage device 900.

The key replacing unit 811 replaces the existing content key included in the content key file by the content key encrypted by the content key encrypting unit 820.

When a request to play back content stored in the storage device 900 is received via a user interface, the search unit 840 either searches the host 800 or requests the PSC 1000 connected to the host 800 to locate a storage key corresponding to the storage device 900.

Based on a result of the search, the playback unit 830 selectively plays back content stored in the storage device 900. In other words, the playback unit 830 ultimately decrypts the content by using the storage key if the storage key is located. If the storage key is not located in either the host 800 or the PSC 1000, the playback unit 830 displays an error message.

The content moving control unit 804 controls moving content stored in the storage device 900. In other words, when an instruction to move content from the first storage device to the second storage device is received, an encrypted content key is decrypted by using a storage key of the first storage device and is re-encrypted by using a storage key of the second storage device.

Then, a content key file, which includes the content key encrypted by using a storage key of the second storage device, and the re-encrypted content are stored in the second storage device, and a content key file and the encrypted content stored in the first storage device are deleted.

Exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs). Also, exemplary embodiments of the present invention can be written as computer programs and can be implemented in general-use digital computers that execute the programs using a computer readable transmission medium. Examples of the computer readable transmission medium include carrier waves (e.g., transmission through the Internet).

While this invention has been particularly shown and described with reference to preferred embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of a host storing digital content in a storage device, the method comprising:
encrypting the content by using a content key;
encrypting the content key by using a storage key, which is a key unique to the storage device; and
storing a content key file, in which the encrypted content key is included, and the encrypted content in the storage device.

2. The method of claim 1, wherein the storage key is a first storage key generated by a PSC (portable security component) connected to the host, and the method further comprises removing the first storage key from the host after the storing of the content key file and the encrypted content is completed.

3. The method of claim 2, further comprising:
determining whether a second storage key, which is a key corresponding to the storage device and is generated by the host, already exists in the host;
extracting the second storage key from the host or newly generating the second storage key, based on a result of the determining;
updating the content key file by using the second storage key;
encrypting the second storage key by using a device key of the host; and
storing the encrypted second storage key in the host.

4. The method of claim 3, wherein the updating of the content key file further comprises:
decrypting the encrypted first storage key by using a device key of the PSC;
decrypting the content key included in the content key file by using the first storage key;
encrypting the decrypted content key by using the second storage key; and
replacing the content key encrypted by using the second storage key with the content key encrypted by using the first storage key.

5. The method of claim 1, wherein the storage key is a second storage key generated by the host, and the method further comprises:
encrypting the second storage key by using a device key of the host; and
storing the encrypted second storage key in the host.

6. The method of claim 5, further comprising:
receiving a first storage key corresponding to the storage device, wherein the key is generated by a PSC connected to the host; and
updating the content key file by using the first storage key.

7. The method of claim 6, wherein the updating of the content key file comprises:
decrypting the encrypted second storage key by using the device key of the host;
decrypting the content key included in the content key file by using the decrypted second storage key;
encrypting the decrypted content key by using the first storage key; and
replacing the content key encrypted by using the first storage key with the content key encrypted by using the second storage key.

8. The method of claim 1, further comprising:
searching for the storage key in either the host or a PSC when a request to play back the content is received; and
selectively playing back the encrypted content based on a result of the searching.

9. The method of claim 8, wherein selectively playing back of the encrypted content comprises:
decrypting a content key, which is included in the content key file, by using the storage key when the storage key is located by the searching; and
decrypting the encrypted content by using the decrypted content key.

10. The method of claim 1, wherein the storage device is a first storage device, and the method further comprises:
receiving an instruction to move the content from the first storage device to a second storage device;
decrypting the encrypted content key by using a first storage key;
encrypting the decrypted content key by using a second storage key, which is a storage key corresponding to the second storage device;
storing a content key file comprising the content key, which is encrypted by using the second storage key, and the encrypted content in the second storage device; and
deleting a content key file and encrypted content stored in the first storage device.

11. The method of claim 1, wherein the content key file further comprises a value for checking integrity of the content key file.

12. The method of claim 1, wherein the content key file further comprises a recovery key, which is generated by encrypting the storage key by using a public key of a third-party manufacturer or a public key of the host.

13. A host storing digital content in a storage device, the host comprising:
a content encrypting unit which encrypts the content by using a content key;
a content key encrypting unit which encrypts the content key by using a storage key which is a key unique to the storage device connected to the host; and
a storage control unit which stores a content key file including the encrypted content key and the encrypted content in the storage device.

14. The host of claim 13, wherein the storage key is a first storage key generated by a PSC (portable security component) connected to the host, and the host comprises a PSC control unit which receives the first storage key from the PSC and deletes the first storage key from the host after the storing of the content key file and the encrypted content in the storage device.

15. The host of claim 14, further comprising:
a storage key generating unit which either extracts a second storage key from the host or generates a new second storage key based on a result of determining whether the second storage key exists in the host or not, wherein the second storage key is a key generated by the host regarding the storage device;
an updating unit which updates the content key file by using the second storage key; and
a storage key managing unit which encrypts the second storage key by using a device key of the host, and stores the encrypted second storage key in the host.

16. The host of claim 15, wherein the updating unit comprises:
a storage key decrypting unit which decrypts the encrypted first storage key by using a device key of the PSC;
a content key decrypting unit which decrypts a content key included in the content key file by using the decrypted first storage key;
a content key encrypting unit which encrypts the decrypted content key by using the second storage key; and
a key replacing unit which replaces the content key encrypted by using the first storage key by the content key encrypted by using the second storage key.

17. The host of claim 13, wherein the storage key is a second storage key generated by the host, and the host further comprises a storage key managing unit which encrypts the second storage key by using a device key of the host and stores the encrypted second storage key in the host.

18. The host of claim 17, further comprising an updating unit which updates the content key file by using a first storage key, wherein the first storage key is a key corresponding to the storage device and is generated by a PSC connected to the host.

19. The host of claim 18, wherein the updating unit comprises:
a storage key decrypting unit which decrypts the encrypted second storage key by using a device key of the PSC;
a content key decrypting unit which decrypts a content key included in the content key file by using the decrypted second storage key;
a content key encrypting unit which encrypts the decrypted content key by using the first storage key; and
a key replacing unit which replaces the content key encrypted by using the second storage key by the content key encrypted by using the first storage key.

20. The host of claim 13, the host comprising:
a search unit which searches for the storage key either in the host or a PSC connected to the host when a request to play back the content is received; and
a content playback unit which selectively plays back the encrypted content based on a result of the searching for the storage key.

21. The host of claim 20, wherein when the storage key is located, the content playback unit decrypts a content key, which is included in the content key file, by using the storage key, and decrypts the encrypted content by using the decrypted content key.

22. The host of claim 13, wherein the storage device is a first storage device, and the host further comprises a content moving control unit which decrypts the encrypted content key by using a first storage key, encrypts the decrypted content key by using a second storage key, stores a content key file, which includes the content key encrypted by using the second storage key, and the encrypted content in the second storage device, and deletes the content key file and the encrypted content stored in the first storage device, when an instruction to move the content from the first storage device to a second storage device is received, wherein the second storage key is a storage key corresponding to the second storage device.

23. The host of claim 13, wherein the content key file further comprises a value to check integrity of the content key file.

24. The host of claim 13, wherein the content key file further comprises a recovery key, which is generated by encrypting the storage key by using a public key of a third-party manufacturer or a public key of the host.

25. A computer readable recording medium having recorded thereon a computer program for executing the method of claim 1.
